(19) United States
(12) Patent Application Publication
(10) Pub. No.: US 2017/0226861 A1
(43) Pub. Date: Aug. 10, 2017

(54) ROTARY ASSEMBLY FOR A TURBINE ENGINE COMPRISING A SELF-SUPPORTED ROTOR COLLAR

(71) Applicants: SAFRAN AIRCRAFT ENGINES, Paris (FR); SAFRAN CERAMICS, Le Haillan (FR)

(72) Inventors: Gael Frederic Claude Cyrille EVAIN, Moissy-Cramayel Cedex (FR); Pierre-Louis Alexandre CARLOS, Moissy-Cramayel Cedex (FR); Claire Charlotte GROLEAU, Moissy-Cramayel Cedex (FR); Mathieu Louis Jean LEDUC, Moissy-Cramayel Cedex (FR); David MARSAL, Saint Andre de Cubzac (FR)

(73) Assignees: SAFRAN AIRCRAFT ENGINES, Paris (FR); SAFRAN CERAMICS, Le Haillan (FR)

(21) Appl. No.: 15/519,351

(22) PCT Filed: Oct. 15, 2015
(86) PCT No.: PCT/FR2015/052776

§ 371 Date: Apr. 14, 2017

(30) Foreign Application Priority Data
Oct. 15, 2014 (FR) 1459888
Oct. 15, 2014 (FR) 1459889

(51) Int. Cl. F01D 5/02; F01D 25/24; F01D 25/00; F04D 29/52; F04D 29/54; F04D 29/02; F01D 9/04; F04D 19/02

(52) U.S. Cl. CPC F01D 5/022; F01D 9/041; F01D 25/24; F04D 19/022; F04D 29/522; F04D 29/542; F04D 29/023; F01D 25/005; F05D 2300/6033

(57) ABSTRACT

A rotary assembly for a turbine engine is provided. The assembly includes a rotor with two consecutive rotor stages equipped with a plurality of movable vanes, and an annular rotor shroud connecting the two consecutive rotor stages; and a stator including a stator stage, provided with a plurality of fixed vanes and disposed between the two rotor stages, and an annular stator ring mounted on the fixed vanes. Either the rotor shroud or the stator ring bears at least one wiper designed to cooperate with an abradable track on the other of the rotor shroud and stator ring, such that the rotor shroud includes at at least one of its upstream or downstream ends an inclined contact portion resting on an inclined bearing surface of the corresponding rotor stage, the bearing surface being the outer surface of a projection extending from a base portion of the corresponding rotor stage.

### FIELD OF THE INVENTION

The present presentation relates to a rotor assembly for a turbine engine, preferably of the turbine type, enabling better control of the radial play between two coaxial pieces. The present presentation focuses mainly on the field of aircraft turbojet engines but can apply in general to any type of turbine engine, in the aeronautic field or not.

### PRIOR ART

In a turbine of a turbine engine, the rotor is driven by the air of the stream which expands at the rotor blades, on this occasion relinquishing some of its energy to the latter. However, it is frequently clear that some of the air stream, generally called “bypass”, flows around the internal and outer platforms of the bladings and therefore does not expand at the bladings, thus reducing the performance of the turbine.

To limit this ineffective air circulation which avoids the blades, the tips of the mobile blades of the rotor are generally equipped withwipers adapted to notch a track of abradable material carried by the stator, ensuring sealing of the stream at the tips of the mobile blades. A similar device is provided for the fixed blades (or nozzles): a shroud known as “labyrinth” is in fact provided between two wheels of mobile blades and bears wipers adapted to notch a track of abradable material carried by the root of the fixed blades, ensuring sealing of the stream at the root of the fixed blades.

However, for this system to be effective, it is important to minimise radial plays separating the wipers of the abradable tracks. Now, a high and even temperature prevailing in the turbine, differential dilation phenomena of some elements can occur and modify the plays between some pieces, in particular between those pieces made of different materials or located more or less near the air stream and therefore subject to more or less high temperatures. For example, radial displacement of the labyrinth shroud is less than that of the fixed blades: therefore, an increase in the play separating the wipers carried by the labyrinth shroud of the abradable track carried by the fixed blades is noted, and therefore also an increase in the bypass circulation and a reduction in performance of the turbine.

To resolve this problem and rectify these plays in operation, a system of valves allows cold air to circulate along the outer wall of the turbine casing to cool this casing and therefore control its dilation, which has an impact on the radial plays, the fixed blades being fixed to this casing. However, such a system has the disadvantage of collecting a considerable rate of fresh air which can therefore not serve to other equipment of the turbine engine.

Another disadvantage of current turbines is that the differential dilation occurring between the labyrinth shroud, or the ring bearing the abradable track, and the members on which they are mounted generates considerable mechanical stresses at the interface between these pieces, causing premature damage and therefore a reduction in their service life.

There is therefore a real need for a rotor assembly for a turbine engine which is at least partly devoid of the disadvantages inherent to the above known config urations.

### PRESENTATION OF THE INVENTION

The present presentation relates to a rotor assembly for turbine engine, of turbine or compressor type, comprising a rotor comprising at least two consecutive rotor stages fitted with a plurality of mobile blades, and a rotor shroud, annular, connecting said two consecutive rotor stages; a stator comprising at least one stator stage, fitted with a plurality of fixed blades, provided between said two consecutive rotor stages, and a stator ring, annular, mounted on said fixed blades; in which one of the elements among the rotor shroud and the stator ring bears at least one wiper configured to cooperate with an abradable track carried by the other of said elements; the rotor shroud comprises, at each of its upstream and downstream ends, either an axial type contact portion extending below a stop of the corresponding rotor stage, or an oblique type contact portion resting on an oblique support surface of the corresponding rotor stage.

In the present presentation, the terms “longitudinal”, “transversal”, “lower”, “upper”, “under”, “on”, and their derivatives are defined relative to the main direction of the blades; the terms “axial”, “radial”, “tangential”, “internal”, “outer” and their derivatives are as such defined relative to the main axis of the turbine engine; “axial plane” means a plane passing through the main axis of the turbine engine and “radial plane” means a plane perpendicular to this main axis; finally, the terms “upstream” and “downstream” are defined relative to circulation of air in the turbine engine.

In such a rotor assembly, thanks to these contact portions of the rotor shroud, traditionally called “labyrinth shroud”, the rotor shroud is mounted between the rotor stages but the movements of radial dilation of the rotor stages do not or only slightly influence the position of the rotor shroud.

In fact, in the case of an axial type contact portion, when idle, the stop of the rotor stage holds the rotor shroud against gravity but, when operating, when the entire rotor stage dilates under the effect of heat brought in by the air of the stream, the stop shifts outwards by moving outwardly away from the contact portion of the rotor shroud: the dilation movement of the rotor stage is therefore not communicated to the rotor shroud.

In the case of an oblique type contact portion, this contact portion rests on the oblique support surface of the rotor stage: in this way, when the rotor stage dilates under the effect of heat, the support surface moves outwards and takes the rotor shroud along with it. However, simultaneously, the rotor assembly in its entirety also dilates axially, increasing the distance separating the two consecutive rotor stages: therefore, the oblique type contact portion of the rotor shroud slides along the oblique surface of the rotor stage and therefore moves inwards and down. The inclination of the support surface and of the contact portion can thus be adjusted to control the total radial displacement of the rotor shroud which is the sum of these two contributions; this radial displacement can especially be cancelled substantially.

Thus, dilation of the rotor stages, generally considerable, has no more, or almost no more impact on the radial position of the rotor shroud: this position is then governed solely by the properties specific to the rotor shroud (especially its thermal dilation coefficient) and its temperature. In this way, it is easy to control the position of the rotor shroud and limit the play separating the wipers and the coincident abradable strip by acting on these parameters, especially by selecting material of low thermal dilation coefficient.

Also, due to such a configuration the rotor shroud and the rotor stages can dilate differently without radial mechanical stresses occurring at the interface between these pieces, which prolongs the service life of the rotor assembly.

In addition, the stop, in the case of axial type contact, or the contact surface, in the case of oblique type contact, prevent air of the stream from flowing around the rotor shroud and entering the inter-disc space.

In some embodiments, the rotor is configured so as to axially block the rotor shroud or draw it towards a stable axial position. This ensures that the axial position of the shroud is stable during operation of the rotor assembly and that it continues to ensure sealing of the inter-disc space. In particular, by construction, in the case of oblique type contact, the oblique support surface of the rotor stage automatically draws the rotor shroud which slides on this surface towards a stable position.

In some embodiments, the rotor shroud comprises an end portion, forming an axial type contact portion, which extends radially outwards and engages in a hook part advancing axially then inwards from a base part of the corresponding rotor stage. The hook part axially blocks the rotor shroud but leaves relative axial displacement free as far as the stop formed by the hollow of the hook.

In some embodiments, the rotor shroud comprises an end portion, forming an axial type contact portion, which extends axially and engages under a projection advancing axially from a base part of the corresponding rotor stage.

In some embodiments, a stop of the rotor stage extends from the root of a mobile blade or from a low wall or a flange connecting the roots of the mobile blades. When the base part of the rotor stage is a low wall or a flange, it extends preferably at 360°, continuously or sectored, along this element.

In some embodiments, an oblique type contact portion has the same inclination as the oblique support surface of the corresponding rotor stage.

In some embodiments, the inclination of the oblique type contact portion relative to the main axis of the rotor assembly is between 15 and 75°, preferably between 35 and 65°. In such a value range, the sliding of the rotor shroud inwards along the oblique contact surface, caused by axial dilation of the rotor assembly, compensates rather accurately outwards displacement caused by radial dilation of the rotor stages.

In some embodiments, an oblique support surface of a rotor stage is the outer surface of a projection advancing from a base part of the rotor stage, preferably from the root of a mobile blade or from a low wall or a flange connecting the roots of the mobile blades. This projection can take the form of an annular groove extending at 360° continuously or sectored.

In some embodiments, an oblique support surface of a rotor stage is the outer surface of a support shroud connected to or forming an integral part of a base part of the rotor stage. This support shroud is preferably continuous over 360° or split.

In some embodiments, the support shroud comprises an end portion which extends radially outwards and engages in a hook part advancing axially then inwards from the base part of the rotor stage. This is a way of fixing the position of this support shroud.

In some embodiments, the rotor comprises a drive device for driving the rotor shroud in rotation when the rotor stages turn. In operation, the rotor shroud turns solid with the rotor stages, ensuring adequate operation of the rotor.

In some embodiments, the drive device comprises drive projections carried, for some of these projections, by an element connected to the rotor stages and, for others of these projections, by the rotor shroud and configured to cooperate with each other so as to drive the rotor shroud in rotation when the rotor stages turn. In this way, when the rotor stages turn, the projections of the rotor stages push and drive the projections of the rotor shroud without hindering the radial displacement freedom of the rotor shroud.

In some embodiments, each rotor stage comprises a disc on which are mounted the mobile blades of the corresponding rotor stage, an inter-disc shroud connecting the discs of the two consecutive rotor stages, and the drive device comprises drive projections provided, for some of them, on the inter-disc shroud and, for others, under the rotor shroud and configured to cooperate with each other so as to drive the rotor shroud in rotation when the rotor stages turn. The rotor shroud can especially comprise tabs extending inwards in the direction of the inter-disc shroud and cooperating with bosses of the inter-disc shroud.

In some embodiments, some play is left between the end of the drive projections of the rotor shroud and the inter-disc shroud. In this way, the rotor shroud is not supported on the inter-disc shroud and is therefore no shifted radially when the inter-disc shroud dilates.

In some embodiments, the drive device comprises drive projections provided, for some of them, on the support shroud and, for others, under the rotor shroud and configured to cooperate with each other so as to drive the rotor shroud in rotation when the rotor stages turn. These projections are preferably grooves meshing in each other.

In some embodiments, the drive device comprises drive projections carried, for some of them, by the base part of a rotor stage and, for others, by the rotor shroud and configured to cooperate with each other so as to drive the rotor shroud in rotation when the rotor stages turn. These projections are preferably grooves meshing in each other.

In some embodiments, the abradable track is carried by the stator ring and said at least one wiper is carried by the rotor shroud. The inventors have indeed noted that the inverse configuration is less favourable.

In some embodiments, the rotor shroud is made of composite material with ceramic matrix. This material is lighter, resists heat well and has a lower dilation coefficient than that of the metal. Its good resistance to heat especially reduces or even cancels cooling circulation of the inter-disc space and therefore reduces air bleeding upstream, improving the performance of the turbine engine.

In some embodiments, the mobile blades, and more generally the rotor stages, are made of metal.

In some embodiments, the stator ring is mounted on the fixed blades by means of a fastening device involving a plurality of radial slots, each slot being made in a radial tab of the stator ring or a radial tab connected to the fixed blades, and a plurality of pins, each pin being carried by a radial tab of the stator ring or a radial tab connected to the fixed blades and configured to engage in a corresponding slot of said radial slots.

In such a rotor assembly, due to this fastening device the stator ring is mounted on the fixed blades but its radial dilation/contraction movements are totally decorrelated from those of the fixed blades. In fact, when dilation of the fixed blades is greater than that of the stator ring, for example due to a higher temperature or material having a higher dilation coefficient, the pins of the fastening device can move freely in the radial slots and therefore not communicate their movement to the stator ring.

Therefore, the stator ring and the fixed blades can dilate differently without mechanical stresses occurring at the interface between these pieces, which prolongs the service life of the rotor assembly.

Also, dilation of the fixed blades, generally considerable, has no more impact on the radial position of the stator ring: this position is then governed solely by the properties specific to the stator ring, essentially its temperature and its thermal dilation coefficient, and no longer depends on a long chain of dimensions of different pieces mounted on each other. In this way, it is easy to control the position of the stator ring and limit the play separating the wipers and the abradable coincident strip by acting on these parameters, especially by selecting a material of low thermal dilation coefficient. In addition, a cooling system of the casing for the sole aim of controlling these plays is superfluous, since the stator ring is no longer connected radially to the casing, which economises on fresh air for other equipment.

In any case it must be emphasised that if the stator ring is free to move in radial dilation/contraction about the main axis of the rotor assembly, this fastening device tangentially blocks the stator ring: this stator ring therefore cannot turn and remains attached to the stator. The radial tabs connected to the fixed blades and carried by the stator ring can also axially wedge the stator ring relative to the fixed blades.

Also, if at least two radial slots are directed in two different directions, this fastening device automatically centres the rotor ring on the main axis of the rotor assembly.

In some embodiments, each radial slot of the fastening device is made in a radial tab of the stator ring.

In some embodiments, each pin of the fastening device is carried by a radial tab connected to the fixed blades.

In some embodiments, a nozzle ring combines the roots of the fixed blades, this nozzle ring comprising a radial flange which bears at least some pins of the fastening device and/or in which at least some radial slots of the fastening device are made. This nozzle ring can be continuous over 360°, split or sectorised. This radial flange extends therefore on 360° and prevents the passage of air at the level of the fastening device, which disallows a configuration comprising a plurality of separate and discontinuous tabs.

In some embodiments, the nozzle ring is sectorised and each of its sectors bears a pin. Each sector preferably comprises three to five fixed blades.

In some embodiments, the stator ring comprises a first radial flange which bears at least some pins of the fastening device and/or in which at least some radial slots of the fastening device are made. The stator ring can be continuous over 360° or split; this radial flange therefore extends over 360° and prevents passage of air at the level of the fastening device, which disallows a configuration comprising a plurality of separate and discontinuous tabs. Also, it is possible to press this radial flange against the radial flange of the nozzle ring to axially wedge the stator ring easier relative to the fixed blades.

In some embodiments, the stator ring comprises a second radial flange, each radial tab connected to the fixed blades being configured to engage between the first and second radial flanges of the stator ring. The radial tabs connected to the fixed blades, preferably taking the shape of a radial flange, are engaged between the first and second flanges of the stator ring, ensuring axial blockage of the rotor ring relative to the fixed blades.

In some embodiments, the second radial flange of the stator ring is solid, that is, has no opening. Therefore the circulation of air passing through the fastening device is impeded even more.

In some embodiments, at least some radial slots are oblong bores extending radially.

In some embodiments, at least some radial slots are oblong notches extending radially from the edge of their respective radial tabs.

In some embodiments, the radial slots of the fastening device are evenly spaced in a radial plane right around the stator ring. This ensures a configuration having at least some symmetries, making centring of the stator ring easier and improving its behaviour in operation.

In some embodiments, the stator ring is made of composite material with ceramic matrix. This material is lighter, resists heat well and has a dilation coefficient less than that of metal.

In some embodiments, the fixed blades and the nozzle ring are made of metal.

In some embodiments, the stator ring and the rotor shroud have thermal dilation coefficients close to each other, preferably equal to ±10%, more preferably equal to ±5%. In this way, these two self-supported pieces move substantially in the same way in operation.

In some embodiments, the stator ring and the rotor shroud are made of the same material.

The present presentation also relates to a rotor assembly for turbine engine, of turbine or compressor type, comprising a rotor comprising at least two consecutive rotor stages fitted with a plurality of mobile blades, and a rotor shroud, annular, connecting said two consecutive rotor stages; a stator comprising at least one stator stage, fitted with a plurality of fixed blades, provided between said two consecutive rotor stages, and a stator ring according to any one of the embodiments presented hereinabove, mounted on said fixed blades, in which one of the elements of the rotor shroud and the stator ring bears at least one wiper configured to cooperate with an abradable track carried by the other of said elements.

The present presentation also relates to a turbine engine comprising a rotor assembly according to any one of the preceding embodiments.

The above characteristics and advantages, as well as others, will emerge from the following detailed description of embodiments of the rotor assembly and of the turbine engine as proposed. This detailed description makes reference to the attached diagrams.

### BRIEF DESCRIPTION OF DIAGRAMS

The attached diagrams are schematic and aim especially to illustrate the principles of the invention.

In these diagrams, from one figure (FIG) to the other, identical elements (or parts of elements) are marked by the same reference numerals. Also, elements (or parts of elements) belonging to different embodiments but having a similar function are marked in the figures by reference numerals incremented as 100, 200, etc.

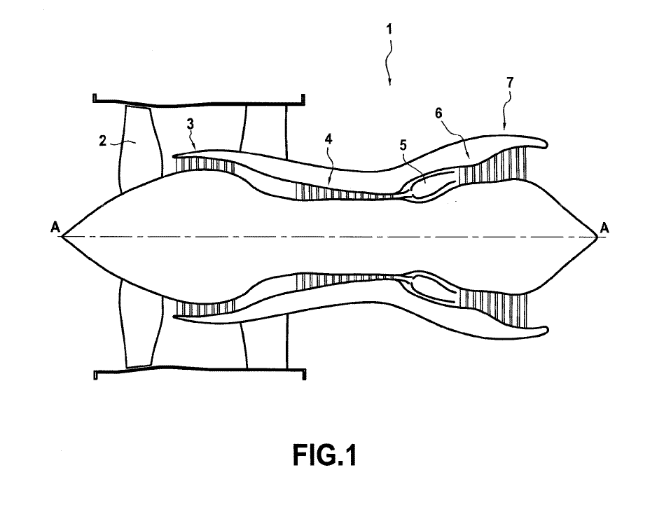

FIG. 1 is a view in axial section of an example of a turbojet engine.

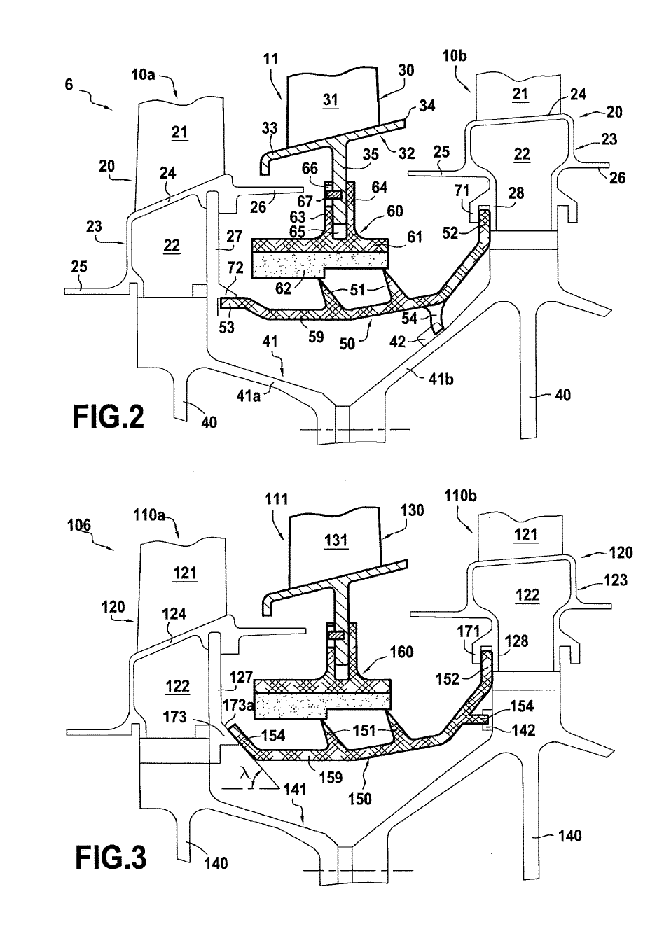

FIG. 2 is a view in axial section of a first example of rotor assembly.

FIG. 3 is a view in axial section of a second example of rotor assembly.

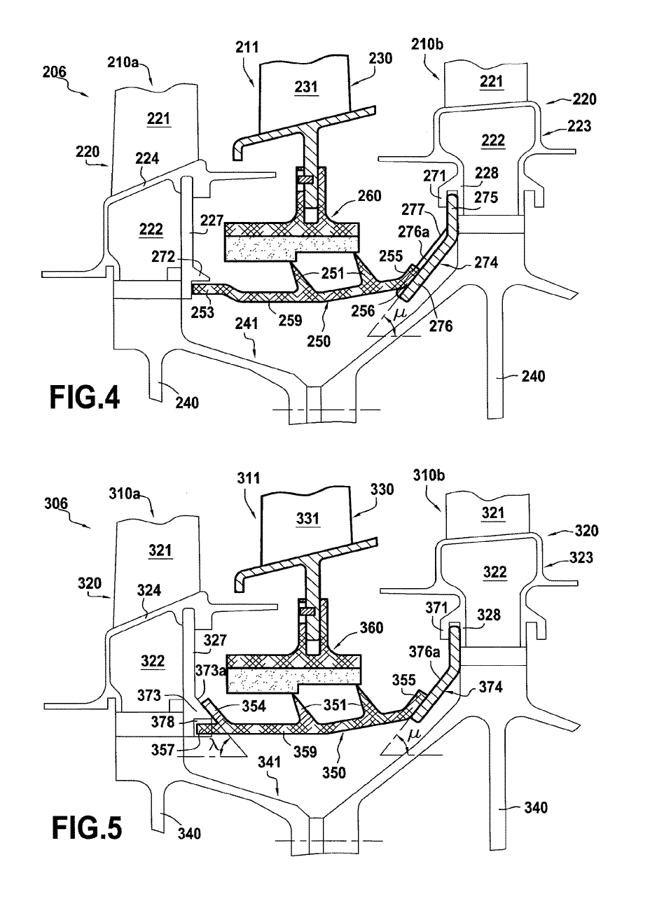

FIG. 4 is a view in axial section of a third example of rotor assembly.

FIG. 5 is a view in axial section of a fourth example of rotor assembly.

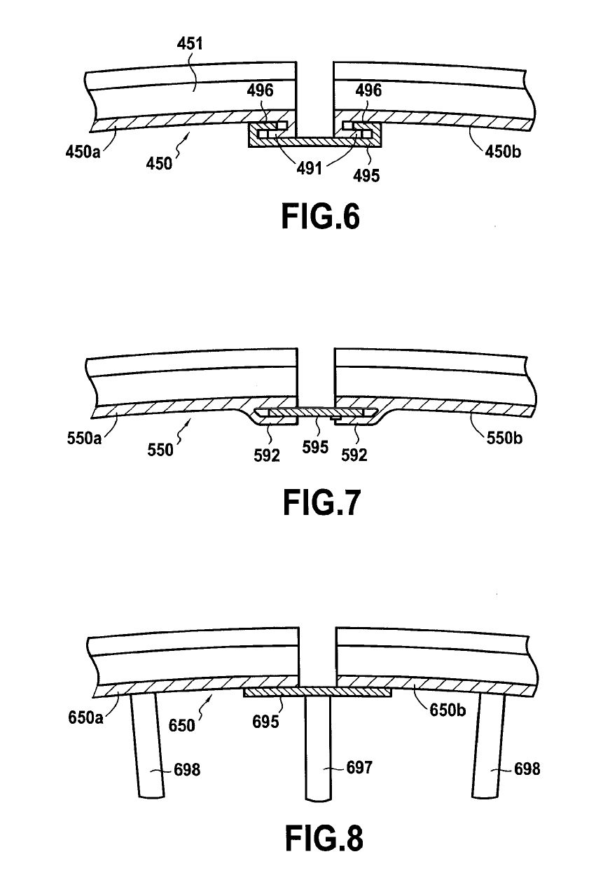

FIG. 6 is a view in radial section of a first example of split shroud.

FIG. 7 is a view in radial section of a second example of split shroud.

FIG. 8 is a view in radial section of a third example of split shroud.

### DETAILED DESCRIPTION OF EMBODIMENTS

To make the invention more concrete, examples of rotor assemblies are described in detail hereinbelow, in reference to the attached diagrams. It is reminded that the invention is not limited to these examples.

In a section according to a vertical plane passing via its main axis A, FIG. 1 shows a double-flow turbojet engine 1 according to the invention. From upstream to downstream, it comprises a fan 2, a low-pressure compressor 3, a high-pressure compressor 4, a combustion chamber 5, a high-pressure turbine 6 and a low-pressure turbine 7.

In a section according to the same axial plane, FIG. 2 shows a part of this low-pressure turbine 7 according to a first embodiment. It is evident indirectly that the invention would apply quite similarly to the high-pressure turbine 6. This turbine 7 comprises a plurality of rotor stages 10a, 10b and stator stages 11 in succession from upstream to downstream, each rotor stage 10a, 10b being immediately followed by a stator stage 11. For simplification purposes, only a first rotor stage 10a, a stator stage 11 and a second rotor stage 10b are shown here.

Each rotor stage 10a, 10b comprises a plurality of mobile rotor blades 20, each comprising a blade 21 and a root 22, mounted on a disc 40 coupled to a shaft of the turbine engine 1. Each stator stage 11 comprises as such a plurality of fixed stator blades 30, each comprising a blade 31, mounted on the outer casing of the turbine 7.

In this embodiment, the rotor blades 20 and the stator blades 30 comprise essentially metallic materials.

The discs 40 of each rotor stage 10a, 10b are connected together in pairs by metallic shrouds 41 called inter-disc shrouds. These shrouds 41 are formed here by two semi-shrouds 41a, 41b each extending from a disc 40 and bolted to each other at their contact point.

The roots 22 of the blades 20 of the first rotor stage 10a are connected by an annular structure of a blade root 23 forming platforms 24, an upstream spoiler 25 and a downstream spoiler 26. A flange 27, annular, is also attached to the downstream face of the blade roots 22 so as to join them. All these elements are preferably made of metallic material. The platforms 24 define the inner limit of the air stream flowing in the turbine 7.

The roots 22 of the blades 20 of the second rotor stage 10b are also fitted with an annular structure of a similar blade root 23 forming platforms 24, an upstream spoiler 25 and a downstream spoiler 26.

The blades 20 of the first and second rotor stages 10a, 10b are also connected by a shroud 50, called labyrinth shroud. This labyrinth shroud 50, annular, is made of composite material with 3D woven ceramic matrix (CMC) by a weaving method known as “contour weaving”. The “contour weaving” is a known weaving technique of a fibrous texture of axisymmetric form in which the fibrous structure is woven on a mandrel with call for warp threads, the mandrel having an outer profile defined according to the profile of the fibrous texture to be made.

The roots of the blades 30 of the stator stage 11 are connected by a nozzle ring 32, formed from several contiguous sectors, extending at 360° about the main axis A. This nozzle ring 32, made of metal, has upstream 33 and downstream 34 projections capable of forming chicanes with the spoilers 26 and 25 upstream 10a and downstream 10b rotor stages. It has also a radial flange 35 extending radially inwards right along the nozzle ring 32.

An abradable ring holder 60 is connected to the nozzle ring 32: it comprises an axial part 61, cylindrical in revolution, bearing tracks of abradable material 62, as well as two radial flanges 63 and 64 extending radially outwards. These two radial flanges 63, 64 define between them an interstice 65 whereof the width corresponds substantially to the width of the radial flange 35 of the distributor ring 32. The downstream radial flange 64 is solid while the upstream radial flange 63 comprises several radial bores 66 evenly spaced about the main axis A: a radial bore 66 can for example be provided relative to the middle of each sector of the nozzle ring 32.

The abradable ring holder 60 is mounted on the nozzle ring 30 by engaging the radial flange 35 of the nozzle ring 30 in the interstice 65 and mounting pieces 67 crimped in this radial flange 35 via the radial bores 66 of the upstream flange 63 of the abradable ring holder 60. This blocks the axial and tangential positions of the abradable ring holder 60 relative to the nozzle ring 32 and leaves its radial displacement free.

The labyrinth shroud bears wipers 51 whereof the tips are in contact with the abradable tracks 62 of the abradable ring holder 60 so as to impede passage of air at the root of the fixed blades 30. This abradable ring holder 60 is also made of 3D woven CMC; a material identical to that of the labyrinth shroud 50 is preferably selected so as to have an identical thermal dilation coefficient between these two pieces and therefore ensure continuous control of plays separating the wipers 51 of the abradable tracks 62.

In this first example, the labyrinth shroud 50 is mounted between the rotor stages 10a, 10b according to an axial/axial configuration. The shroud 50, oriented substantially axially in its median portion 59 bearing the wipers 51, straightens up outwards in the direction of its downstream end to form, at its downstream end, an axial type contact portion 52 extending radially. This contact portion 52 is supported axially against a low wall 28 of the structure of blade root 23 of the downstream rotor stage 10b and engages in a hook part 71 advancing axially then radially inwards from this low wall 28, this hook part 71 therefore being located more outside than the contact portion 52 of the shroud 50: the axial position of the labyrinth shroud 50 is now blocked relative to the downstream rotor stage 10b but their relative radial displacements remain free. This hook part 71 is symmetrical in revolution relative to the axis A of the turbine 7 and therefore has a constant profile over the entire circumference of the labyrinth shroud 50.

The upstream end of the labyrinth shroud 50 has a second axial type contact portion 53 extending axially under, that is, more inside, a groove 72 advancing axially from the flange 27 of the upstream rotor stage 10a and extending 360° about the axis A: the mobile blades 20 can dilate radially without causing displacement of the labyrinth shroud 50. Also, when the turbine 7 dilates axially the labyrinth shroud 50 follows the axial movement of downstream the rotor stage 10b but its upstream end continues to overlap the groove 72, limiting the passage of the stream of air in the inter-disc space.

The labyrinth shroud 50 also comprises tabs 54, provided evenly about the axis A, which extend from its inner surface towards the metallic inter-disc shroud 41. This shroud has bosses 42, provided evenly about the axis A in the same radial plane as the feet 54: so, when the rotor turns, these bosses 42 enter into contact with the tabs 54 and drive the labyrinth shroud 50 in rotation together with the entire rotor. A clearance however is left between the tabs 54 and the inter-disc shroud 41 so that the inter-disc shroud 41 does not push the labyrinth shroud 50 radially when it dilates.

FIG. 3 illustrates a second example of rotor assembly 107 similar to the first example, except for the labyrinth shroud 150 and its mounting between the rotor stages 110a and 110b, the labyrinth shroud 150 being mounted here according to an oblique/axial configuration.

In this second example, the downstream end of the labyrinth shroud 150 is similar to that of the first example: it also comprises an axial type contact portion 152 extending radially and engaging in a hook part 171 advancing axially then radially inwards from a low wall 128 of the structure of blade root 123 of the downstream rotor stage 110b.

However, its upstream end forms an oblique type contact portion 154 which extends in an oblique direction the inclination of which forms an angle λ of around 40° relative to the main axis A of the turbine 107. This oblique contact portion 154 rests on the outer surface 173a of a projection 173 advancing from the flange 127 of the first rotor stage 110a. This outer surface 173a extends according to the same oblique inclination as that of the contact portion 154 and therefore forms the same angle λ of around 40° relative to the main axis A.

Accordingly, when the first rotor stage 110a dilates, the axial component of this dilation tends to lower the shroud 150 along the oblique surface 173a of the projection 173, which compensates the ascending movement of the shroud 150 due to the radial component of this dilation of the first rotor stage 110a: the radial position of the labyrinth shroud 150 stays substantially unchanged. This projection 173 is preferably symmetrical in revolution relative to the axis A of the turbine 107 and therefore has a constant profile over the entire circumference of the labyrinth shroud 150.

The device for driving the labyrinth shroud 150 in rotation is also different to that of the first example. Here, tabs 154 are also carried by the labyrinth shroud 150 but they are directed towards the disc 140 of the downstream rotor stage 110b to cooperate with bosses 142 provided on the upstream face of this disc 140.

FIG. 4 illustrates a third example of rotor assembly 207 similar to the first example except for the labyrinth shroud 250 and its mounting between the rotor stages 210a and 210b, the labyrinth shroud 250 here being mounted according to an axial/oblique configuration.

In this third example, the upstream end of the labyrinth shroud 250 is similar to that of the first example: it also comprises an axial type contact portion 253 extending axially under, that is, more inside, a groove 272 advancing axially from the flange 227 of the upstream rotor stage 210a.

However, its downstream end has a configuration of oblique type of form different to that of the second example. Here, the downstream rotor stage 210b also comprises a rotationally symmetric support shroud 274, which comprises a hook portion 275, extending radially and engaging in a hook part 271 similar to that of the first example, and an oblique support portion 276 whereof the outer surface 276a forms an oblique support surface the inclination of which forms an angle μ of around 55° relative to the main axis A of the turbine 207.

The labyrinth shroud 250 comprises at its downstream end an oblique type contact portion 255 which extends in an oblique direction, whereof the inclination forms the same angle μ of around 55° relative to the main axis A, and rests on the support surface 276a of the support shroud 276. Similarly, this oblique support surface 276a produces a certain compensation in radial displacement of the shroud 250 caused by the radial and axial components of the dilation of the rotor stage 210b.

The device for driving the labyrinth shroud 250 in rotation is also different to those of the first and second examples. Here, corresponding flutes 256 and 277 are provided respectively on the inner surface of the oblique contact portion 255 of the labyrinth shroud 250 and on the support surface 276a of the support shroud 276.

FIG. 5 illustrates a fourth example of rotor assembly 307 similar to the first example except for the labyrinth shroud 350 and its mounting between the rotor stages 310a and 310b, the labyrinth shroud 350 being mounted here according to an oblique/oblique configuration.

However, in this fourth example, the upstream end of the labyrinth shroud 350 is similar to that of the second example: it also comprises an oblique type contact portion 354, which extends in an oblique direction whereof the inclination forms an angle λ of around 40° relative to the main axis A of the turbine 307, and rests on the outer surface 373a of a projection 373 advancing from the flange 327 of the first rotor stage 310a.

The downstream end of the labyrinth shroud 350 is similar to that of the third example: it also comprises an oblique type contact portion 355, which extends in an oblique direction whereof the inclination forms the same angle μ of around 55° relative to the main axis A, and rests on the support surface 376a of a support shroud 374 similar to that of the third example.

The device for driving the labyrinth shroud 350 in rotation is again different in this fourth example. Here, teeth 357 advancing from the labyrinth shroud 350, more precisely from the intersection between its median portion 359 and its contact portion 354, mesh in flutes 378 of the flange 327. These flutes are preferably machined here in the lower portion of the projection 373.

In each of these examples, the labyrinth shroud 50 is preferably continuous over 360° such that it is auto-supported in the turbine 7 about the main axis A. But it would also be possible to design a split or sectorised labyrinth shroud 450 so as to simplify its mounting or reduce tangential mechanical stresses.

But, in such a case a tight connection device should be put in place between the sectors 450a, 450b of the shroud 450. Such devices are presented in FIGS. 6 to 9.

A first solution, shown in FIG. 6, is that of sealing in the form of clips: this involves creating over-lengths 491 during weaving of the labyrinth shroud 450; hereinbelow these will be folded back to create a hook for a wafer 495 also fitted with folded back tabs 496, this wafer 495 ensuring sealing.

This sealing wafer 495 can also be made of CMC, which limits problems of differential dilation or resistance to temperature.

During setting in rotation, the sealing wafer 495 is pressed against the labyrinth shroud 450, under the effect both of centrifugal force and under the effect of the opening of the sectors 450a, 450b of the labyrinth shroud 450 also, and enables good sealing.

Also, the length of the different hooks 491 is dimensioned as a function of the maximal opening of the space separating the sectors 450a, 450b during operation so that at any moment of operation the wafer 495 is both held by the shroud 450 and on the other hand no overstress is exerted on the wafer 495 during opening of the sectors 450a, 450b.

An axial blockage can be arranged in the form of a small notch on the folded back hooks 491 of the labyrinth shroud 450.

A second solution, shown in FIG. 7, is that of a sealing wafer 595 held by disconnections 592 of the labyrinth shroud 550: this solution is very similar to the preceding and functions in the same way except that in this case, the wafer 595 is held by tabs 592 obtained by disconnection of the woven structure of the labyrinth shroud 550.

A third solution uses a wafer 695 fitted with a branch 697. Under the effect of centrifugal force, the wafer 695 is pressed against the sectors 650a, 650b of the labyrinth shroud, creating sealing.

The retention and the driving in rotation of the wafer 695 and the sectors 650a, 650b can be ensured by means of a crenellated fastening device similar to that described in French patent application FR 13 57776 and shown especially in FIGS. 6 and 7 of this application: in such a crenellated fastening device the branches 697 and 698 of the wafer 695 and sectors 650a, 650b of the labyrinth shroud 650 are received between the merlons of the crenellated profile, ending in axial and tangential blockage of these elements and retaining their freedom of movement according to the radial direction.

The modes or embodiments described in the present presentation are given by way of illustrative and non-limiting example, an expert easily able, in the light of this explanation, to modify these modes or embodiments, or envisage others, while remaining within the scope of the invention.

Also, the different characteristics of these modes or embodiments can be used singly or can be combined together. When combined, these characteristics can be as described hereinabove or differently, the invention not being limited to the specific combinations described in the present presentation. In particular, unless expressed otherwise, a characteristic described in relation to a mode or embodiment can be applied similarly to another mode or embodiment.

1. A rotor assembly for a turbine engine, of the turbine or compressor type, comprising:
a rotor comprising:
at least two consecutive rotor stages fitted with a plurality of mobile blades, and
an annular rotor shroud connecting said two consecutive rotor stages; and
a stator comprising:
at least one stator stage, fitted with a plurality of fixed blades, provided between said two consecutive rotor stages, and
a stator ring which is annular and mounted on said fixed blades;
in which one of the rotor shroud and the stator ring bears at least one wiper configured to cooperate with an abradable track carried by the other of the rotor shroud and the stator ring
wherein at least one of an upstream end and a downstream end of the rotor shroud comprises:
an oblique type contact portion resting on an oblique support surface of the corresponding rotor stage, said oblique support surface being the outer surface of a projection advancing from a base part of the corresponding rotor stage.

2. The rotor assembly as claimed in claim 1, wherein the rotor is configured so as to axially block the rotor shroud or draw the rotor shroud towards a stable axial position.

3. The rotor assembly as claimed in claim 1, in wherein an oblique type contact portion has the same inclination as the oblique support surface of the corresponding rotor stage, and
wherein the inclination of the oblique type contact portion relative to the main axis of the rotor assembly is between 15° and 75°.

4. The rotor assembly as claimed in claim 1, wherein the inclination of the oblique type contact portion relative to the main axis of the rotor assembly is between 35° and 75°, preferably between 35° and 65°.

5. The rotor assembly as claimed in claim 1, wherein said projection advances from the root of a mobile blade or from a low wall or a flange connecting the roots of the mobile blades.

6. The rotor assembly as claimed in claim 1, wherein said projection is an annular groove.

7. The rotor assembly as claimed in claim 1, wherein an oblique support surface of a rotor stage is the outer surface of a support shroud connected to or forming an integral part of a base part of the rotor stage.

8. The rotor assembly as claimed in claim 7, wherein the support shroud comprises an end portion which extends radially outwards and engages in a hook part advancing axially then inwards from the base part of the rotor stage.

9. The rotor assembly as claimed claim 1, wherein the rotor comprises a drive device for driving the rotor shroud in rotation when the rotor stages turn.

10. The rotor assembly as claimed in claim 9, wherein the drive device comprises drive projections carried, for some, by an element connected to the rotor stages and, for others, by the rotor shroud and configured to cooperate with each other so as to drive the rotor shroud in rotation when the rotor stages turn.

11. The rotor assembly as claimed in claim 1, in which wherein the abradable track is carried by the stator ring and said at least one wiper is carried by the rotor shroud.

12. The rotor assembly as claimed in claim 1, wherein the rotor shroud is made of composite material with ceramic matrix.

13. The rotor assembly as claimed in claim 1, wherein the stator ring is mounted on the fixed blades by a fastening device involving
a plurality of radial slots, each slot being made in a radial tab of the stator ring or a radial tab connected to the fixed blades, and
a plurality of pins, each pin being carried by a radial tab of the stator ring or a radial tab connected to the fixed blades and configured to engage in a corresponding slot of said radial slots.

14. The rotor assembly as claimed in claim 13, wherein the stator ring and the rotor shroud have thermal dilation coefficients equal to ±10%.

15. A turbine engine, comprising a rotor assembly as claimed in claim 1.
